(19) United States
(12) Patent Application Publication
(10) Pub. No.: US 2013/0139327 A1
(43) Pub. Date: Jun. 6, 2013

(54) TEXTILE TREATMENT COMPOSITION FOR REMOVAL OF DEODORANT STAINS

(71) Applicant: Henkel AG & Co. KGaA, Duesseldorf (DE)

(72) Inventors: Fabian Sieben, Leverkusen (DE); Regina Stehr, Neuss (DE); Michael Dreja, Neuss (DE)

(73) Assignee: Henkel AG & Co. KGaA, Duesseldorf (DE)

(21) Appl. No.: 13/756,617

(22) Filed: Feb. 1, 2013

Related U.S. Application Data
(63) Continuation of application No. PCT/US2011/062405, filed on Jul. 20, 2011.

(30) Foreign Application Priority Data
Aug. 3, 2010 (DE) 10 2010 038 829.7

(51) Int. Cl. C11D 3/20

(52) U.S. Cl. 8/137

(57) ABSTRACT

The invention relates to a textile treatment agent having an organic acid, an inorganic acid, a nonionic surfactant, and a deodorizing compound, which removes or reduces the occurrence of incrustations, discolorations, and unpleasant odors in textiles resulting from the application of deodorants.

### FIELD OF THE INVENTION

The present invention generally relates to a textile treatment agent encompassing a deodorizing compound. The invention also relates to the use of such a textile treatment agent.

### BACKGROUND OF THE INVENTION

Deodorant spots on textiles are stains that are known to be difficult to remove. These spots occur when the deodorant gets directly onto the textile, but in particular also when the ingredients of the deodorant, in particular the aluminum salts, are transferred together with perspiration onto the textile when it is being worn.

As a result of the alkaline pH of the washing bath upon subsequent washing of the textiles, the aluminum salts are precipitated onto the textile and fixed on the fabric; this becomes evident by way of incrustations, discolorations, or odor generation. Odor generation is intensified if the washed textile is exposed to heat and moisture at the locations having the fixed aluminum salts, for example when ironed or when worn (as a result of body heat and new perspiration).

The discolorations result from fats that are contained in the perspiration and are transferred onto the textile, and from fat- or oil-containing ingredients of the deodorant.

DE 10043118 A1 discloses a washing agent that contains a deodorizing compound and counteracts the generation of unpleasant odors in textiles treated therewith.

An object of this invention was to make available a textile treatment agent that is capable of decreasing the undesired effects, such as incrustations, discolorations, or odor generation, that result from contact between deodorants and textiles when textiles are washed and/or worn.

This object is achieved by a textile treatment agent comprising

a) an organic acid,

b) an inorganic acid,

c) a nonionic surfactant, and

d) a deodorizing compound.

Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A textile treatment agent comprising an organic acid, an inorganic acid, a nonionic surfactant, and a deodorizing compound.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

An acid-containing textile treatment agent is capable of dissolving or loosening the incrustations resulting from perspiration and aluminum salts. As a result, the deodorizing compound can penetrate into the incrustations and/or into the fabric, and act in targeted fashion on unpleasant odors. In the case of textile treatment agents having no acid, the deodorizing compounds can act only superficially, since they cannot penetrate through the tenacious incrustations. In addition to its cleaning and/or fat-dissolving action, the nonionic surfactant also serves as a solubilizer for the unpleasant odors, so that they can more effectively be transported away in the washing process via the washing bath.

It is preferred that the organic acid be selected from the group consisting of citric acid, formic acid, acetic acid, tartaric acid, malic acid, oxalic acid, lactic acid, and mixtures thereof. It is particularly preferred that the organic acid encompass citric acid and/or formic acid.

It is further preferred that the inorganic acid be selected from the group consisting of phosphoric acid, hydrochloric acid, and mixtures thereof.

In a further preferred embodiment, the deodorizing compound is selected from the group consisting of zinc ricinoleate, zinc abietate, cyclodextrin, essential oils, triethylene glycol, sodium hydrogen carbonate, and mixtures thereof. These compounds are known and effective deodorizing compounds.

In a particularly preferred embodiment, the textile treatment agent additionally contains a liquid hydrophobic compound. The addition of a liquid hydrophobic compound allows the discoloration caused principally by fats and/or oils to be removed.

It is preferred that the liquid hydrophobic compound be selected from the group comprising benzine, C_{11- 13} isoparaffin, C₁₆₋₂₀ isoparaffin, C₈₋₁₃ isoparaffin, C₉₋₁₂ isoparaffin, limonene, dioctyl ether, and mixtures thereof. These compounds, in particular limonene and dioctyl ether, exhibit high spreadability and therefore penetrate effectively into the textile fabric and into the fat- and oil-containing stains present thereon. All these hydrophobic compounds are liquid at room temperature (23° C.). Because of their low molecular weight, these compounds are volatile and can thus be removed from the textile fabrics easily and with no residue. In addition, these compounds are either odor-neutral or in fact have a pleasant odor.

It is further preferred that the textile treatment agent have a pH in the range from 1.5 to 4.5. The highly acid pH of the textile treatment agent allows the aluminum-salt-containing incrustations to be dissolved or loosened.

The invention also relates to the use of a textile treatment agent according to the present invention in the washing, cleaning, and/or pretreatment of textile fabrics.

The invention will be explained in further detail below, in part with reference to examples.

The textile treatment agent contains an organic acid as an essential constituent. The organic acid can encompass citric acid, formic acid, acetic acid, tartaric acid, malic acid, oxalic acid, lactic acid, or mixtures thereof It is particularly preferred that the organic acid encompass citric acid. Citric acid is odor-neutral, inexpensive, and has water-softening properties. In a particularly preferred embodiment, the textile treatment agent contains citric acid and formic acid.

The quantity of organic acid is by preference between 5 and 30 wt %, and more preferably between 10 and 20 wt %, based in each case on the total textile treatment agent.

The textile treatment agent contains an inorganic acid as a second essential constituent. The inorganic acid preferably encompasses phosphoric acid, hydrochloric acid, or mixtures thereof. The inorganic acid is added in particular so that the textile treatment agent has an acid pH of less than 7, by preference a pH in the range from 1.5 to 4.5.

The quantity of inorganic acid is by preference between 0.5 and 10 wt % and more preferably between 1 and 5 wt %, based in each case on the total textile treatment agent.

The textile treatment agent contains a nonionic surfactant as a third essential constituent.

Suitable nonionic surfactants encompass alkoxylated fatty alcohols, alkoxylated fatty acid alkyl esters, fatty acid amides, alkylpolyglucosides, alkoxylated fatty acid amides, polyhydroxy fatty acid amides, N-methylglucamides, alkylphenyl polyglycol ethers, and mixtures thereof.

The nonionic surfactants used are by preference alkoxylated, advantageously ethoxylated, in particular primary alcohols having by preference 8 to 18 carbon atoms and an average of 1 to 12 mol ethylene oxide (EO) per mol of alcohol, in which the alcohol residue can be linear or preferably methyl-branched in the 2-position, or can contain mixed linear and methyl-branched residues, such as those that are usually present in oxo alcohol residues. Particularly preferred, however, are alcohol ethoxylates having linear residues made up of alcohols of natural origin having 12 to 18 carbon atoms, e.g. from coconut, palm, tallow, or oleyl alcohol, and an average of 2 to 8 EO per mol of alcohol. The preferred ethoxylated alcohols include, for example, C₁₂₋₁₄ alcohols with 3 EO, 4 EO or 7 EO, C₉₋₁₁ alcohol with 7 EO, C₁₃₋₁₅ alcohols with 3 EO, 5 EO, 7 EO, or 8 EO, C₁₂₋₁₈ alcohols with 3 EO, 5 EO or 7 EO, and mixtures thereof, such as mixtures of C₁₂₋₁₄ alcohol with 3 EO and C₁₂₋₁₈ alcohol with 7 EO. The degrees of ethoxylation indicated represent statistical averages, which can correspond to an integer or a fractional number for a specific product. Preferred alcohol ethoxylates exhibit a restricted distribution of homologs (narrow range ethoxylates, NRE). In addition to these nonionic surfactants, fatty alcohols with more than 12 EO can also be used. Examples of these are tallow fatty alcohol with 14 EO, 25 EO, 30 EO, or 40 EO. Nonionic surfactants that contain EO and PO groups together in the molecule are also usable according to the present invention. A mixture of a (more highly) branched ethoxylated fatty alcohol and an unbranched ethoxylate fatty alcohol is also suitable, for example a mixture of a C₁₆₋₁₈ fatty alcohol with 7 EO and 2-propylheptanol with 7 EO. Particularly preferably, the textile treatment agent contains as a nonionic surfactant a C₁₂₋₁₈ fatty alcohol with 7 EO, a C₁₂₋₁₄ fatty alcohol with 3 EO, a C₁₂₋₁₄ alcohol with 2 EO, a C₁₂₋₁₆ fatty alcohol with 7 EO, or a C₁₃₋₁₅ oxoalcohol with 5 EO.

Preferred amine oxides are, for example, N-cocalkyl-N,N-dimethylamine oxide, N-tallowalkyl-N,N-dihydroxyethylamine oxide, myristyl/cetyl dimethylamine oxide, or lauryl dimethylamine oxide.

Also usable as further nonionic surfactants are alkyl glycosides of the general formula RO(G)ₓ in which R signifies a primary straight-chain or methyl-branched aliphatic residue, in particular methyl-branched in the 2- position, having 8 to 22, by preference 12 to 18 carbon atoms, and G is the symbol which denotes a glycose unit having 5 or 6 carbon atoms, preferably glucose. The degree of oligomerization x, which indicates the distribution of monoglycosides and oligoglycosides, is any number between 1 and 10; x is preferably 1.2 to 1.4.

The quantity of nonionic surfactant is by preference between 0.5 and 20 wt % and more preferably between 1 and 15 wt %, based in each case on the total textile treatment agent.

The textile treatment agent contains a deodorizing compound as a fourth essential constituent. The deodorizing compound by preference encompasses zinc ricinoleate, zinc abietate, cyclodextrin, essential oils, triethylene glycol, sodium hydrogen carbonate, or mixtures thereof, zinc ricinoleate preferably being used as a deodorizing compound. The effect of zinc ricinoleate is based on odor neutralization, i.e. chemical bonding to the odoriferous substances so that they are no longer sensorially perceptible, and thus differs in terms of principle of action from other deodorizing systems such as odor-masking compounds or odor(ant)-destroying compounds.

The quantity of deodorizing compound is by preference between 0.01 and 5 wt % and more preferably between 0.1 and 2 wt %, based in each case on the total textile treatment agent.

In a particularly preferred embodiment of the invention, the textile treatment agent additionally contains a liquid hydrophobic compound. “Liquid” means, in connection with this invention, that the hydrophobic compound used is in a liquid aggregate state at 23° C. The liquid hydrophobic compound by preference has a molecular weight in the range from 100 to 600. Liquid hydrophobic compounds having a molecular weight from 100 to 600 are volatile and therefore do not remain behind on the textile fabrics treated therewith. The problem of enriched deposition of the liquid hydrophobic compound onto the textile fabrics is thereby avoided. It is therefore particularly preferred if the molecular weight of the hydrophobic compound used is in the range from 100 to 300.

Suitable liquid hydrophobic compounds encompass benzine, C₁₁₋₁₃ isoparaffin, C₁₆₋₂₀ isoparaffin, C₈₋₁₃ isoparaffin, C₉₋₁₂ isoparaffin, limonene, dioctyl ether, or mixtures thereof.

The term “benzene” designates a petroleum distillation fraction having a boiling range from approx. 80 to 110° C.

Limonene is a natural substance from the group of the terpenes (monocyclic monoterpene). There are two enantiomers, (R)-(+)-limonene (also referred to as D-(+)-limonene), and (S)-(−)-limonene (also referred to as L-(−)-limonene). The two enantiomers alone, or the racemate of the two enantiomers (also referred to as “dipentene”) can be used in each case as a liquid hydrophobic compound.

Limonene has good spreading properties and therefore penetrates effectively into textile fabrics and into the oil- and/or fat-containing discolorations present thereof. Limonene moreover has a pleasant odor.

Dioctyl ether is a colorless, odor-neutral oil, and has a high spreadability of 1600 mm²/10 min. Dioctyl ether is obtainable, for example, under the designation Cetiol CE (from Cognis).

In addition to the four essential constituents, the textile treatment agent can contain further ingredients that further improve the applications-engineering and/or aesthetic properties of the textile treatment agent. In the context of the present invention, the textile treatment agent by preference additionally contains one or more substances from the group of the anionic surfactants, builders, bleaching agents, bleach catalysts, bleach activators, enzymes, thickening agents, electrolytes, nonaqueous solvents, pH adjusting agents, perfume compositions, perfume carriers, fluorescing agents, dyes, hydrotopes, foam inhibitors, silicone oils, soil release polymers, anti-gray agents, shrinkage preventers, crease prevention agents, color transfer inhibitors, further antimicrobial active substances, germicides, fungicides, antioxidants, preservatives, corrosion inhibitors, antistatic agents, bittering agents, ironing adjuvants, proofing and impregnation agents, swelling and anti-slip agents, softening components, and UV absorbers.

Particularly preferred additional ingredients are anionic surfactants, builders, enzymes, electrolytes, nonaqueous solvents, pH adjusting agents, perfume compositions, fluorescing agents, dyes, hydrotopes, foam inhibitors, soil release polymers, anti-gray agents, color transfer inhibitors, thickening agents, UV absorbers, and mixtures thereof.

The textile treatment agents according to the present invention are by preference liquid, and contain water as a principal solvent. In addition, the textile treatment agent by preference has an acid pH. The textile treatment agent can be a washing agent, a pretreatment agent, or a washing-agent additive. The textile treatment agent is by preference a washing-agent additive that is used together with a washing agent in the main washing cycle, or a pretreatment agent that is applied in targeted fashion onto the deodorant spots, for example by spraying or with a roll-on applicator.

A textile treatment agent according to the present invention is manufactured by means of usual and known methods and processes. For example, the constituents of the washing or cleaning agents can be simply mixed in agitator vessels; usefully, water, the acid components, such as e.g. citric acid, formic acid, phosphoric acid, etc., and the nonionic surfactants are first made ready. The nonaqueous solvents, if present, are by preference also added at this time, but can also be added at a later time. The further constituents are then added, by preference in portions.

### EXEMPLIFYING EMBODIMENTS

Table 1 shows the compositions of four textile treatments E1 to E4 according to the present invention (all quantities are indicated in wt % based on the composition):

TABLE 1

| | E1 | E2 | E3 | E4 |
|---|---|---|---|---|
| C₁₂₋₁₈ fatty alcohol with 7 EO | — | — | — | 3.5 |
| C₈₋₁₀ alkylpolyglycoside | 2 | 5 | 5 | — |
| Citric acid | 10 | 15 | 15 | 15 |
| Phosphoric acid | 1 | 3 | 2.5 | 2.5 |
| Formic acid | 0.5 | 1.5 | 1 | 1 |
| Zinc ricinoleate | 0.1 | 1 | 0.5 | 0.5 |
| Limonene | — | — | — | 1.5 |
| C₁₁₋₁₃ isoparaffin | — | — | 2 | — |
| Xanthan | — | 0.35 | 0.8 | 0.8 |
| Perfume | 0.3 | 0.3 | 0.3 | 0.3 |
| NaOH | 0.85 | 0.35 | 0.35 | 0.35 |
| Dyes | — | + | + | + |
| Water | to 100 | to 100 | to 100 | to 100 |
| pH | 2.05 | 1.5 | 1.5 | 1.5 |

All four textile treatment agents E1 to E4 were capable of removing or considerably reducing incrustations and discolorations that result from the application of deodorants. In addition, textiles that had been treated with the textile treatment agents according to the present invention exhibited a considerably reduced generation of unpleasant odors when worn, in particularly in the underarm region. Textile treatment agents E3 and E4 exhibited particularly good effectiveness against discolorations that had occurred due to the application of deodorants.

The textile treatment agents according to the present invention exhibit cleaning performance not only in the context of incrustations, discolorations, and unpleasant odors that result from the application of deodorants, but also with respect to a plurality of further spots and stains.

The ability of textile treatment agent E1 to remove spots was determined via a determination of chromaticity Y (DIN 5033). For this, a household washing machine (Miele W 526) was loaded with 3.5 kg of accompanying laundry as well as stained cloth swatches. In addition, 90 ml of a liquid heavy-duty washing agent was dispensed in. In one case the stained cloth swatches were pretreated with textile treatment E1 by spraying it on and leaving it to act for 30 minutes. The Y values were determined at 420 nm (apparatus: Datacolor Spectraflash 600, 30 mm aperture).

TABLE 2
Remission: Y value

| | Stain without | Stain pretreated |
|---|---|---|
| Stain type | pretreatment | with E1 |
| Underarm perspiration | 18.3 | 24.3 |
| Gravy | 62.2 | 74.0 |
| Coffee | 64.4 | 69.6 |
| Blueberries | 64.2 | 72.2 |
| Blackcurrants | 51.5 | 56.1 |
| Blackberries | 55.9 | 62.9 |
| Pomegranate | 79.4 | 87.7 |
| Red wine (Bordeaux) | 70.0 | 79.3 |
| Instant tea | 45.5 | 73.5 |
| Fruit tea | 61.8 | 78.2 |
| Herbal tea | 56.0 | 85.9 |
| Shoe polish | 51.9 | 61.7 |

It is evident from the data of Table 2 that a plurality of different stains, in particular berry, coffee, tea, and red wine stains, can be considerably reduced with the aid of textile treatment agent E1 .

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A textile treatment agent comprising
a) an organic acid,
b) an inorganic acid,
c) a nonionic surfactant, and
d) a deodorizing compound.

2. The textile treatment agent according to claim 1, wherein the organic acid is selected from the group consisting of citric acid, formic acid, acetic acid, tartaric acid, malic acid, oxalic acid, lactic acid, and mixtures thereof.

3. The textile treatment agent according to claim 2, wherein the organic acid encompasses citric acid and/or formic acid.

4. The textile treatment agent according to claim 1, wherein the inorganic acid is selected from the group consisting of phosphoric acid, hydrochloric acid, and mixtures thereof.

5. The textile treatment agent according to claim 1, wherein the deodorizing compound is selected from the group consisting of zinc ricinoleate, zinc abietate, cyclodextrin, essential oils, triethylene glycol, sodium hydrogen carbonate, and mixtures thereof.

6. The textile treatment agent according to claim 1, wherein the textile treatment agent additionally contains a liquid hydrophobic compound.

7. The textile treatment agent according to claim 6, wherein the liquid hydrophobic compound is selected from the group consisting of benzine, C₁₁₋₁₃ isoparaffin, C₁₆₋₂₀ isoparaffin, C₈₋₁₃ isoparaffin, C₉₋₁₂ isoparaffin, limonene, dioctyl ether, and mixtures thereof.

8. The textile treatment agent according to claim 1, wherein the textile treatment agent has a pH in the range from 1.5 to 4.5.

9. A method washing, cleaning, and/or conditioning of textile fabrics wherein the textile treatment agent according to claim 1 is introduced into a household washing machine.
